(19) United States
(12) Patent Application Publication
(10) Pub. No.: US 2023/0295475 A1
(43) Pub. Date: Sep. 21, 2023

(54) AQUEOUS CURABLE ADHESIVE COMPOSITION AND A LAMINATED ARTICLE COMPRISING THE SAME

(71) Applicants: Dow Global Technologies LLC, Midland, MI (US); Rohm and Haas Company, Collegeville, PA (US)

(72) Inventors: Yin Xue, Shanghai (CN); ChenYan Bai, Shanghai (CN); Gaobing Chen, Shanghai (CN); Lianjiang Zhao, Shanghai (CN); Qiuying Wang, Shanghai (CN); Weifang Zhang, Shanghai (CN)

(21) Appl. No.: 18/041,461

(22) PCT Filed: Sep. 8, 2020
(86) PCT No.: PCT/CN2020/113911

§ 371 Date: Feb. 13, 2023

(51) Int. Cl. C09J 133/06; B32B 7/12; B32B 27/32; B32B 27/08

(52) U.S. Cl. CPC C09J 133/064; B32B 7/12; B32B 27/32; B32B 27/08; B32B 2255/26; B32B 2255/10; B32B 2307/518; B32B 2250/242; B32B 2307/748; B32B 2439/70; B32B 2439/80; B32B 2250/02

(57) ABSTRACT

An aqueous curable adhesive composition comprises an aqueous polymer dispersion and a polyamine compound having at least two amino groups. A laminated article comprises at least two substrates and the aqueous curable adhesive composition.

### FIELD OF THE INVENTION

The present disclosure relates to an aqueous curable adhesive composition, in particular an aqueous curable adhesive composition for lamination applications; and also a laminated article comprising at least two substrates and an aqueous curable adhesive composition.

### INTRODUCTION

Flexible packaging laminating adhesives are applied between laminating films (two or multi layers) for packaging of food, pharmaceuticals, and industrial consumables. Based on the adhesive compositions, laminating adhesives can be classified into three categories: solventborne (SB), solventless (SL) and waterborne (WB). Therein, WB acrylic adhesive is the most popular due to its benefits like easy handling, environment friendliness, and so on. With the expansion of applications, the requirements on performances, especially bonding strength between films, are greatly increased. Accordingly, there is a strong need in the art to design new binders or formulations having desirable performances such as bonding strength.

### SUMMARY OF THE INVENTION

The present disclosure provides a novel aqueous curable adhesive composition that has desirable performances, such as bonding strength.

In a first aspect, the present disclosure provides an aqueous curable adhesive composition comprising:
A) an aqueous polymer dispersion, wherein the polymer is polymerized from a monomer mixture comprising
   (i) 90-99.9 wt % of one or more ethylenically unsaturated nonionic monomers;
   (ii) 0.1-10 wt % of an ethylenically unsaturated acid monomer;
   wherein the percentages are based on the total weight of the monomer mixture; and
B) a polyamine compound having at least two amino groups;
   wherein the content of component B) is 0.5-10 wt % based on the solid weight of A) the aqueous polymer dispersion.

In a second aspect, the present disclosure provides a laminated article comprising at least two substrates and an aqueous curable adhesive composition comprising:
A) an aqueous polymer dispersion, wherein the polymer is polymerized from a monomer mixture comprising
   (i) 90-99.9 wt % of one or more ethylenically unsaturated nonionic monomers;
   (ii) 0.1-10 wt % of an ethylenically unsaturated acid monomer;
   wherein the percentages are based on the total weight of the monomer mixture; and
B) a polyamine compound having at least two amino groups;
   wherein the content of component B) is 0.5-10 wt % based on the solid weight of A) the aqueous polymer dispersion.

In a third aspect, the present disclosure provides a method for preparing the aqueous curable adhesive composition comprising:
blending B) a polyamine compound having at least two amino groups with A) an aqueous polymer dispersion, wherein the polymer is polymerized from a monomer mixture comprising
   (i) 90-99.9 wt % of one or more ethylenically unsaturated nonionic monomers;
   (ii) 0.1-10 wt % of an ethylenically unsaturated acid monomer;
   wherein the percentages are based on the total weight of the monomer mixture; and
   wherein the content of component B) is 0.5-10 wt % based on the solid weight of A) the aqueous polymer dispersion.

In a fourth aspect, the present disclosure provides a method for improving the bonding strength of an aqueous curable adhesive composition comprising A) an aqueous polymer dispersion, comprising:
adding B) a polyamine compound having at least two amino groups to A) the aqueous polymer dispersion, wherein the polymer is polymerized from a monomer mixture comprising
   (i) 90-99.9 wt % of one or more ethylenically unsaturated nonionic monomers;
   (ii) 0.1-10 wt % of an ethylenically unsaturated acid monomer;
   wherein the percentages are based on the total weight of the monomer mixture; and
   wherein the content of component B) is 0.5-10 wt % based on the solid weight of A) the aqueous polymer dispersion.

It is to be understood that both the foregoing general description and the following detailed description are exemplary and explanatory only and are not restrictive of the invention, as claimed.

### DETAILED DESCRIPTION OF THE INVENTION

Unless defined otherwise, all technical and scientific terms used herein have the same meaning as commonly understood by one of ordinary skill in the art to which the invention belongs. Also, all publications, patent applications, patents, and other references mentioned herein are incorporated by reference.

As disclosed herein, the term “composition”, “formulation” or “mixture” refers to a physical blend of different components, which is obtained by mixing simply different components by a physical means.

As disclosed herein, the term “Glass transition temperature” (T_{g}) can be measured by various techniques including, for example, differential scanning calorimetry (DSC) or calculation by using a Fox equation.

Throughout this document, “Acrylic” in the present disclosure includes (meth)acrylic acid, (meth)acrylate, (meth)acrylamide, (meth)acrylonitrile and their modified forms such as hydroxyalkyl (meth)acrylate. The word fragment “(meth)acryl” refers to both “methacryl” and “acryl”. For example, (meth)acrylic acid refers to both methacrylic acid and acrylic acid, methyl (meth)acrylate refers to both methyl methacrylate and methyl acrylate and (meth)acryamide refers to both methacryamide and acryamide.

“Aqueous” composition or dispersion herein means that particles dispersed in an aqueous medium. By “aqueous medium” herein is meant water and from 0 to 30%, by weight based on the weight of the medium, of water-miscible compound(s) such as, for example, alcohols, glycols, glycol ethers, glycol esters, and the like.

“Mixtures thereof” or “a mixture thereof” means a mixture of two or more of the listed substance or materials.

The aqueous curable adhesive composition of the present disclosure comprises A) an aqueous polymer dispersion, wherein the polymer in the aqueous polymer dispersion is referred as polymer a), which can be polymerized from a monomer mixture.

The monomer mixture for preparing the polymer a) useful in the present disclosure may comprise one or more ethylenically unsaturated nonionic monomers. “Nonionic monomers” herein refer to monomers that do not bear an ionic charge between pH=1-14. Examples of suitable ethylenically unsaturated nonionic monomers include (meth)acrylic ester monomers, preferably alkyl (meth)acrylate, more preferably C1-18 alkyl (meth)acrylate or C1-12 alkyl (meth)acrylate or C1-6 alkyl (meth)acrylate such as methyl acrylate, ethyl acrylate, butyl acrylate, 2-ethylhexyl acrylate, nonyl acrylate, decyl acrylate, isodecyl acrylate, lauryl acrylate, methyl methacrylate, ethyl methacrylate, butyl methacrylate, nonyl methacrylate, decyl methacrylate, isodecyl methacrylate, lauryl methacrylate or mixtures thereof; hydroxyalkyl (meth)acrylate, more preferably C2-18 hydroxyalkyl (meth)acrylate or C2-12 hydroxyalkyl (meth)acrylate or C2-6 hydroxyalkyl (meth)acrylate such as hydroxyethyl acrylate, hydroxypropyl acrylate, hydroxyethyl methacrylate, hydroxypropyl methacrylate or mixtures thereof; (meth)acrylamide and (meth)acrylonitrile or mixtures thereof. Other suitable nonionic monomers may be further added, for example, styrene and substituted styrene, or other vinyl monomers such as vinyl acetate, vinyl butyrate, vinyl versatate and other vinyl esters, vinyl chloride, vinylidene chloride or mixtures thereof.

In some preferred embodiments, the ethylenically unsaturated nonionic monomers comprise 30% by weight or more, 35% by weight or more, 40% by weight or more, 45% by weight or more, 50% by weight or more or even 55% by weight or more of (meth)acrylic ester monomers, and at the same time, 90% by weight or less, 80% by weight or less, or even 70% by weight or less, 65% by weight or less, or even 60% by weight or less of (meth)acrylic ester monomers, based on the weight of the monomer mixture. In some preferred embodiments, the ethylenically unsaturated nonionic monomers comprise 20% by weight or more, 25% by weight or more, 30% by weight or more, 35% by weight or more, or even 36% by weight or more of styrene and substituted styrene monomers, and at the same time, 80% by weight or less, 70% by weight or less, or even 60% by weight or less, 55% by weight or less, 50% by weight or less, 45% by weight or less, or even 40% by weight or less of styrene and substituted styrene monomers, based on the weight of the monomer mixture.

In some preferred embodiments, the ethylenically unsaturated nonionic monomers comprise 30% by weight or more, 35% by weight or more, 40% by weight or more, 45% by weight or more, 50% by weight or more or even 55% by weight or more of (meth)acrylic ester monomers, and at the same time, 90% by weight or less, 80% by weight or less, or even 70% by weight or less, 65% by weight or less, or even 60% by weight or less of (meth)acrylic ester monomers, based on the weight of the monomer mixture; and comprise 20% by weight or more, 25% by weight or more, 30% by weight or more, 35% by weight or more, or even 36% by weight or more of styrene and substituted styrene monomers, and at the same time, 80% by weight or less, 70% by weight or less, or even 60% by weight or less, 55% by weight or less, 50% by weight or less, 45% by weight or less, or even 40% by weight or less of styrene and substituted styrene monomers, based on the weight of the monomer mixture. Preferably, the A) aqueous polymer dispersion is an acrylic polymer dispersion, more preferably is Robond™ L-168D.

The monomer mixture useful in the present disclosure may comprise, based on the weight of the monomer mixture, 90% by weight or more, 93% by weight or more, or even 96% by weight or more of the ethylenically unsaturated nonionic monomers, and at the same time, 99.9% by weight or less, 99.5% by weight or less, 99% by weight or less, or even 98% by weight or less of the ethylenically unsaturated nonionic monomers.

Examples of suitable ethylenically unsaturated acid monomers include acrylic acid, methacrylic acid, itaconic acid, phosphorus-containing acid monomers like dihydrogen phosphate monomers including 2-phosphoethyl (meth)acrylate, vinyl phosphonic acid, and allyl phosphonic acid; fumaric acid; maleic acid; monomethyl itaconate; monomethyl fumarate; monobutyl fumarate; maleic anhydride; 2-acrylamido-2-methyl-1-propanesulfonic acid; sodium salt of 2-acrylamido-2-methyl-1-propanesulfonic acid; ammonium salt of 2-acrylamido-2-methyl-1-propane sulfonic acid; sodium vinyl sulfonate; sodium salt of allyl ether sulfonate; and mixtures thereof. In some preferred embodiments, acrylic acid, methacrylic acid, itaconic acid, 2-phosphoethyl methacrylate, or a mixture thereof is used as the ethylenically unsaturated acid monomer. In some preferred embodiments, acrylic acid, methacrylic acid, or a mixture thereof is used as the ethylenically unsaturated acid monomer.

The monomer mixture useful in the present disclosure may comprise, based on the weight of the monomer mixture, 0.1% by weight or more, 0.5% by weight or more, 1% by weight or more, 1.5% by weight or more, 1.8% by weight or more, or 2% by weight or more, of the ethylenically unsaturated acid monomers, and at the same time, 10% by weight or less, 8% by weight or less, or even 6% by weight or less, 5% by weight or less, 4% by weight or less, or 3% by weight or less, or 2.5% by weight or less of the ethylenically unsaturated acid monomers.

The aqueous curable adhesive composition of the present disclosure is substantially free of polyfunctional carboxylic hydrazide. Examples of suitable polyfunctional carboxylic hydrazide include adipic dihydrazide, sebacic dihydrazide, polyhydrazide, propylenediamine, cyclohexyldiamine, or mixtures thereof.

The aqueous curable adhesive composition of the present disclosure is substantially free of epoxy resin.

“substantially free of a substance” means when present, the concentration of the substance may be, based on the total weight of the aqueous curable adhesive composition, 0.2% by weight or less, 0.1% by weight or less, or 0.05% by weight or less, or even 0.01% by weight or less.

In one preferred embodiment, the aqueous polymer dispersion A) or the polymer a) is prepared by emulsion polymerization, and is therefore an emulsion polymer.

In the case of emulsion polymerization, a suitable surfactant system and/or protective colloids, or stabilizer is used.

Examples of suitable surfactant systems are those known in the art and include anionic, nonionic, cationic, or amphoteric emulsifiers and mixtures thereof. Examples of anionic surfactants include, but are not limited to, alkyl sulfates, sulfates of ethoxylate alcohols, aryl sulfonates, phosphates of ethoxylated alcohols, sulfosuccinates, sulfates and sulfonates of ethoxylated alkylphenols, and mixtures thereof. Examples of nonionic surfactants include, but are not limited to, ethoxylated alcohols, ethoxylated alkylphenols, and mixtures thereof. Examples of cationic surfactants include, but are not limited to, ethoxylated fatty amines. The typical weight of surfactant is 0.1 to 5.0 wt. % and more preferably 0.3 to 5.0 wt. % and most preferably 0.5 to 3.0 wt. % based on total weight of monomers. The surfactants are utilized by conventional methods that are well known in art. In one embodiment, the process to prepare the COMPOSITION includes the emulsification of the monomer mix with the surfactant system prior to the polymerization reaction.

Examples of surfactant trade names are AEROSOL® A-102, Disponil® FES 77, Dowfax™ 2A1, Abex® 2535 and RHODACAL® DS-4.

Water-soluble initiators for the emulsion polymerization are, for example, ammonium salts and alkali metal salts of peroxodisulfuric acid, e.g., sodium peroxodisulfate, ammonium persulfate, hydrogen peroxide, or organic peroxides, e.g., tert-butyl hydroperoxide.

Also suitable are what are known as reduction-oxidation (redox) initiator systems.

The redox initiator systems are composed of at least one, usually inorganic reducing agent and one organic or inorganic oxidizing agent.

The oxidizing component comprises, for example, the emulsion polymerization initiators already mentioned above.

The reducing component comprises, for example, alkali metal salts of sulfurous acid, such as sodium sulfite, sodium hydrogen sulfite, alkali metal salts of disulfurous acid such as sodium disulfite, bisulfite addition compounds with aliphatic aldehydes and ketones, such as acetone bisulfite, or reducing agents such as hydroxymethanesulfinic acid and its salts, or ascorbic acid. The redox initiator systems may be used together with soluble metal compounds whose metallic component is able to exist in a plurality of valence states.

Examples of customary redox initiator systems include ascorbic acid/iron(II) sulfate/sodium peroxodisulfate, tert-butyl hydroperoxide/sodium disulfite, and tert-butyl hydroperoxide/Na hydroxymethanesulfinate. The individual components, the reducing component for example, may also be mixtures: for example, a mixture of the sodium salt of hydroxymethanesulfinic acid with sodium disulfite.

These compounds are mostly used in the form of aqueous solutions, the lower concentration being determined by the amount of water that is acceptable in the dispersion and the upper concentration by the solubility of the respective compound in water. The concentration is generally from 0.1 to 30% by weight, preferably from 0.5 to 20% by weight, with particular preference from 1.0 to 10% by weight, based on the solution.

The amount of the initiators is generally from 0.1 to 10% by weight, preferably from 0.3 to 5% by weight, based on the monomers to be polymerized. It is also possible for two or more different initiators to be used for the emulsion polymerization.

The emulsion polymerization takes place in general at from 30 to 130° C., preferably from 60 to 95° C. The polymerization medium may be composed either of water alone or of mixtures of water and water-miscible liquids such as methanol. Preferably, only water is used. The emulsion polymerization may be conducted either as a batch operation or in the form of a feed process, including staged or gradient procedures. Preference is given to the feed process in which a portion of the polymerization mixture is introduced as an initial charge and heated to the polymerization temperature, the polymerization of this initial charge is begun, and then the remainder of the polymerization mixture is supplied to the polymerization zone, usually by way of two or more spatially separate feed streams, of which one or more comprise the monomers in straight or emulsified form, this addition being made continuously, in stages or under a concentration gradient, and polymerization being maintained during said addition. It is also possible, in order, for example, to set the particle size more effectively, to include a polymer seed in the initial charge to the polymerization.

The manner in which the initiator is added to the polymerization vessel in the course of the free-radical aqueous emulsion polymerization is known to the skilled worker. It may either be included in its entirety in the initial charge to the polymerization vessel or else introduced, continuously or in stages, at the rate at which it is consumed in the course of the free-radical aqueous emulsion polymerization. In each specific case this will depend both on the chemical nature of the initiator system and on the polymerization temperature. It is preferred to include one portion in the initial charge and to supply the remainder to the polymerization zone at the rate at which it is consumed.

In order to remove the residual monomers, it is common to add initiator after the end of the actual emulsion polymerization as well, i.e., after a monomer conversion of at least 95%.

With the feed process, the individual components can be added to the reactor from the top, through the side, or from below, through the reactor floor.

In the case of emulsion polymerization, aqueous polymer dispersions with solids contents of generally from 15 to 80% by weight, preferably from 30 to 70% by weight, more preferably from 40 to 65% by weight, still more preferably from 40 to 55% by weight, are obtained.

The types and levels of the monomers described above may be chosen to provide the polymer a) with a T_{g} suitable for lamination applications.

The glass transition temperature of the polymer a) may be in the range of from −60° C. to 30° C., from −50° C. to 20° C., or from −40° C. to 10° C.; or with particular preference from −50 to 10° C., and with very particular preference from −45 to 5° C.

The glass transition temperature can be determined by customary methods such as differential thermoanalysis or differential scanning calorimetry (see, for example, ASTM 3418/82, midpoint temperature).

The aqueous polymer dispersion in the adhesive composition of the present disclosure may be present, by solids weight based on the total weight of the aqueous adhesive composition, in an amount of 15% or more, 20% or more, 25% or more, 35% or more, or even 40% or more, and at the same time, 80% or less, 75% or less, 70% or less, 65% or less, 60% or less, 55% or less, or even 45% or less.

The polymer thus prepared is used preferably in the form of its aqueous dispersion.

The pH of the polymer dispersion is preferably adjusted to a pH of more than 4.5, and in particular to a pH of between 5 and 10.

The aqueous adhesive composition of the present disclosure further comprises B) a polyamine compound having at least two amino groups.

Specific examples of B) a polyamine compound having at least two amino functional groups include, but are not limited to, C₂-C₁₆ aliphatic polyamine comprising at least two amine groups, e.g., ethylenediamine, hexamethylene diamine; C₄-C₁₅ cycloaliphatic or aromatic polyamine comprising at least two amino groups, such as cyclohexanediamine and p-xylenediamine; C₇-C₁₅ araliphatic polyamine comprising at least two amino groups; and mixtures thereof. According to a preferable embodiment, the B) polyamine compound having at least two amino functional groups is ethylene diamine, hexamethylene diamine, or a mixture thereof. In another embodiment, the polyamine compound having at least two amino functional groups is ethylene diamine or hexamethylene diamine.

The polyamine compound B) can be added after the emulsion reaction.

The content of polyamine compound B) is 0.5 to 10 wt % based on the solid weight of A) the aqueous polymer dispersion, or 0.6 to 9.5 wt % based on the solid weight of A) the aqueous polymer dispersion, in particular 0.68 to 9 wt % based on the solid weight of A) the aqueous polymer dispersion, and or 1 to 8 wt % based on the solid weight of A) the aqueous polymer dispersion, or 1.1 to 7 wt % based on the solid weight of A) the aqueous polymer dispersion, or 1.5 to 5 wt % based on the solid weight of A) the aqueous polymer dispersion, or 2 to 4 wt % based on the solid weight of A) the aqueous polymer dispersion. The content of polyamine compound B) can be in the numerical range obtained by combining any two of the following end point values 0.5, 0.6, 0.7, 0.8, 0.9, 1, 1.5, 2, 2.5, 3, 3.5, 4, 4.5, 5, 5.5, 6, 6.5, 7, 7.5, 8, 8.5, 9, 9.5 and 10 wt % based on the solid weight of A) the aqueous polymer dispersion.

Polymer a), or the aqueous polymer dispersion A), can be mixed in a simple way with compound B). The resulting mixture is stable on storage.

The aqueous curable adhesive composition may comprise further additives: a thickener, a defoamer, a wetting agent, a mechanical stabilizer, a pigment, a filler, a freeze-thaw agent, a neutralizing agent, a plasticizer, a tackifier (tackifying resin), an adhesion promoter, and combinations thereof.

Examples of tackifiers are natural resins, such as rosins and their derivatives formed by disproportionation or isomerization, polymerization, dimerization and/or hydrogenation. They may be present in their salt form (with, for example, monovalent or polyvalent counterions (cations)) or, preferably, in their esterified form.

Also used are hydrocarbon resins, e.g. non-hydrogenated aliphatic C5 resins, hydrogenated aliphatic C5 resins, aromatic modified C5 resins, terpene resins, hydrogenated C9 resins, and combinations thereof.

Other compounds increasingly being used as tackifiers include polyacrylates which have a low molar weight. These polyacrylates preferably have a weight-average molecular weight MW of less than 30,000. With preference the polyacrylates are composed of at least 60% by weight, in particular at least 80% by weight, of C1-C8 alkyl (meth)acrylates.

Preferred tackifiers are natural or chemically modified rosins. Rosins are composed predominantly of abietic acid or its derivatives.

The amount by weight of tackifiers is preferably from 5 to 100 parts by weight, with particular preference from 10 to 50 parts by weight, per 100 parts by weight of polymer (solids/solids).

The aqueous curable adhesive composition may comprise 0 to 5 percent by weight of a thickener, based on the total weight of the adhesive composition. All individual values and subranges from 0 to 5 percent by weight are included herein and disclosed herein. For example, the wt % of the thickener can be from a lower limit of 0, 0.5, or 1 percent by weight to an upper limit of 1, 3, or 5 percent by weight. Example thickeners include, but are not limited to, ACRYSOL™, UCAR™ and CELOSIZE™ which are commercially available from The Dow Chemical Company, Midland, Mich.

The aqueous curable adhesive composition may comprise 0 to 2 percent by weight of a neutralizing agent, based on the total weight of the adhesive composition.

All individual values and subranges from 0 to 2 percent by weight are included herein and disclosed herein. For example, the wt % of the neutralizing agent can be from a lower limit of 0, 0.3, or 0.5 percent by weight to an upper limit of 0.5, 1, or 2 percent by weight. Neutralizing agents are typically used to control pH to provide stability to the formulated adhesive composition. Examples of the neutralizing agent include, but are not limited to, aqueous ammonia, aqueous amines, and other aqueous inorganic salts.

The aqueous curable adhesive compositions can be used for lamination applications.

The present disclosure also provides a laminated article comprising at least two substrates and an aqueous curable adhesive composition disclosed herein. Preferably, a layer of the aqueous curable adhesive composition is applied to one or both sides, preferably to one side of at least one of the substrates.

To produce the adhesive layer on the substrate, the substrate can be coated conventionally. Customary application rates are, for example, 1 to 50 g/m² (solids, without water).

The two substrates may be the same or different.

The substrate may comprise, for example, paper, metal foils, polymer films preferably made of polyolefins including polyethylene and polypropylene which can be biaxially or monoaxially oriented, such as biaxially oriented polypropylene film (Bopp film) or casting polypropylene film (CPP film), polyethylene terephthalate (PET), polyvinyl chloride (PVC), polystyrene or polyamide. In a preferred embodiment, the substrate may comprise biaxially oriented polypropylene film (Bopp film) or casting polypropylene film (CPP film).

The laminated articles of the disclosure have good performance properties, in particular, improved bonding strength.

The laminated articles can be used for packaging, such as food packages.

### EXAMPLES

Some embodiments of the disclosure will now be described in the following Examples, wherein all parts and percentages are by weight unless otherwise specified.

Raw materials:

Abbreviations used: DI water=deionized water; SC=Solids content by weight;

A: Acrylic polymer aqueous dispersion (Ready-to-use commercial products from DOW Chemical):

| Material | Description | Vendor |
|---|---|---|
| A-I: Robond ™ L-168D | BA/St/AA, Tg = 2° C. | The Dow Chemical Company |
| A-C: Robond ™ L-95D | BA/St/AA, Tg = 2° C. | The Dow Chemical Company |
| B-1: Ethylene Diamine | polyamine | Sinopharm Chemical Reagent |
| B-2: Hexamethylene Diamine | polyamine | Sinopharm Chemical Reagent |

### 1. Formulation

The above raw materials were formulated with proper agitation for 15 mins to obtain a curable aqueous composition according to the formulations listed in Table 2.

TABLE 2
Formulation of Samples.

| | | | | | Ratio of |
|---|---|---|---|---|---|
| | A-I | B-1 | B-2 | A-C | B to A |
| | (SC: 44%) | (100%) | (100%) | (SC: 44%) | (Solids) |
| Blank | | | | | |
| Inventive 1 | 100 | 1 | | | 2.27% |
| Inventive 2 | 100 | 0.5 | | | 1.14% |
| Inventive 3 | 100 | | 1 | | 2.27% |
| Inventive 4 | 100 | | 0.5 | | 1.14% |
| Inventive 5 | 100 | | 0.3 | | 0.68% |
| Comparative 1 | 100 | | | | 0 |
| (Blank) | | | | | |
| Comparative 2 | 100 | 0.2 | | | 0.45% |
| Comparative 3 | 100 | | 0.2 | | 0.45% |
| Control | | | | 100 | |

2. Preparation of a lamination structure and Test of bonding strength

The lamination structure was prepared by the following procedure:
1) The adhesive formulations were directly coated on the BOPP film (available from Wenzhou Gettel Group), respectively;
2) A right wire wound bar (Model No.: 0, available from RK Print, U.K.) was selected to control the dry coating weight of the adhesive at ˜2 gsm;
3) The adhesive was dried at 80° C. for 2 mins;
4) The product obtained in step 3) was laminated with a CPP film (available from Wenzhou Gettel Group), and the nip temperature was 80° C.;
5) The laminates were conditioned at room temperature for 3 days, after which the bonding strength was measured.

The bonding strength of lamination was tested on Instron (available from Instron, U.S.) with the following conditions:
Sample width: 15 mm
Peel rate: 250 mm/min (T-Peel)
Unit: N/15 mm

The results were listed in Table 3

TABLE 3
Bonding Strength of the Formulations
on BOPP/CPP Structure

| | Bonding |
|---|---|
| | Strength |
| | (N/15 mm) |
| Inventive 1 | 1.09 |
| Inventive 2 | 0.9 |
| Inventive 3 | 1.1 |
| Inventive 4 | 0.96 |
| Inventive 5 | 1.08 |
| Comparative 1 | 0.6 |
| Comparative 2 | 0.45 |
| Comparative 3 | 0.63 |
| Control | 1.05 |

By comparing the results of inventive formulations (Inventive 1-5) and Comparative formulation, Comparative 1 (blank), it can be seen that the addition of polyamine can improve the bonding strength of the lamination structure by >50%, and the final bonding strength could be close to the commercial control sample. The improvement will be weakened if the addition level of polyamine is low (Comparative 2, and 3).

1. An aqueous curable adhesive composition comprising:
A) an aqueous polymer dispersion, wherein the polymer is polymerized from a monomer mixture comprising
(i) 90-99.9 wt % of one or more ethylenically unsaturated nonionic monomers;
(ii) 0.1-10 wt % of an ethylenically unsaturated acid monomer;
wherein the percentages are based on the total weight of the monomer mixture; and
B) a polyamine compound having at least two amino groups;
wherein the content of component B) is 0.5-10 wt % based on the solid weight of A) the aqueous polymer dispersion.

2. The composition of claim 1, wherein the ethylenically unsaturated nonionic monomers are selected from (meth)acrylic ester monomers, (meth)acrylamide, (meth)acrylonitrile, styrene, substituted styrene, other vinyl monomers and a mixture of two or more of them.

3. The composition of claim 1, wherein the ethylenically unsaturated nonionic monomers are selected from methyl acrylate, ethyl acrylate, butyl acrylate, 2-ethylhexyl acrylate, nonyl acrylate, decyl acrylate, isodecyl acrylate, lauryl acrylate, methyl methacrylate, ethyl methacrylate, butyl methacrylate, nonyl methacrylate, decyl methacrylate, isodecyl methacrylate, lauryl methacrylate, hydroxyethyl acrylate, hydroxypropyl acrylate, hydroxyethyl methacrylate, hydroxypropyl methacrylate, (meth)acrylamide, (meth)acrylonitrile, styrene, substituted styrene, vinyl acetate, vinyl butyrate, vinyl versatate, vinyl chloride, vinylidene chloride and a mixture of two or more of them.

4. The composition of claim 1, wherein the ethylenically unsaturated acid monomers are selected from acrylic acid, methacrylic acid, itaconic acid, phosphorus-containing acid monomers; fumaric acid; maleic acid; monomethyl itaconate; monomethyl fumarate; monobutyl fumarate; maleic anhydride; 2-acrylamido-2-methyl-1-propanesulfonic acid; sodium salt of 2-acrylamido-2-methyl-1-propanesulfonic acid; ammonium salt of 2-acrylamido-2-methyl-1-propane sulfonic acid; sodium vinyl sulfonate; sodium salt of allyl ether sulfonate; and mixtures thereof.

5. The composition of claim 1, wherein the ethylenically unsaturated acid monomers are selected from acrylic acid, methacrylic acid, and a mixture thereof.

6. The composition of claim 1, wherein the glass transition temperature of the polymer is in the range of from −60° C. to 30° C.

7. The composition of claim 1, wherein the polyamine compound having at least two amino groups is selected from C₂-C₁₆ aliphatic polyamine comprising at least two amine groups, C₄-C₁₅ cycloaliphatic or aromatic polyamine comprising at least two amino groups, C₇-C₁₅ araliphatic polyamine comprising at least two amino groups; and mixtures thereof.

8. The composition of claim 1, wherein the polyamine compound having at least two amino groups is selected from ethylene diamine, hexamethylene diamine, or a mixture thereof.

9. The composition of claim 1, wherein the content of polyamine compound B) is 0.6 to 9.5 wt % based on the solid weight of A) the aqueous polymer dispersion.

10. A laminated article comprising at least two substrates and an aqueous curable adhesive composition comprising:
A) an aqueous polymer dispersion, wherein the polymer is polymerized from a monomer mixture comprising
(i) 90-99.9 wt % of one or more ethylenically unsaturated nonionic monomers;
(ii) 0.1-10 wt % of an ethylenically unsaturated acid monomer;
wherein the percentages are based on the total weight of the monomer mixture; and
B) a polyamine compound having at least two amino groups;
wherein the content of component B) is 0.5-10 wt % based on the solid weight of A) the aqueous polymer dispersion.

11. A method for preparing the aqueous curable adhesive composition comprising:
blending B) a polyamine compound having at least two amino groups with A) an aqueous polymer dispersion, wherein the polymer is polymerized from a monomer mixture comprising
(i) 90-99.9 wt % of one or more ethylenically unsaturated nonionic monomers;
(ii) 0.1-10 wt % of an ethylenically unsaturated acid monomer;
wherein the percentages are based on the total weight of the monomer mixture; and
wherein the content of component B) is 0.5-10 wt % based on the solid weight of A) the aqueous polymer dispersion.

12. A method for improving the bonding strength of an aqueous curable adhesive composition comprising A) an aqueous polymer dispersion, comprising:
adding B) a polyamine compound having at least two amino groups to A) the aqueous polymer dispersion, wherein the polymer is polymerized from a monomer mixture comprising
(i) 90-99.9 wt % of one or more ethylenically unsaturated nonionic monomers;
(ii) 0.1-10 wt % of an ethylenically unsaturated acid monomer;
wherein the percentages are based on the total weight of the monomer mixture; and
wherein the content of component B) is 0.5-10 wt % based on the solid weight of A) the aqueous polymer dispersion.
